(19) United States
(12) Patent Application Publication
(10) Pub. No.: US 2022/0027582 A1
(43) Pub. Date: Jan. 27, 2022

(54) METHOD FOR READING OUT DEVICE PARAMETERS OF A FIELD DEVICE AND A CORRESPONDING FIELD DEVICE

(71) Applicant: TURCK Holding GmbH, Halver (DE)

(72) Inventors: Hermann Schwagmann, Detmold (DE); Thomas Kriegel, Luedenscheid (DE)

(21) Appl. No.: 17/380,035

(22) Filed: Jul. 20, 2021

(30) Foreign Application Priority Data
Jul. 22, 2020 (DE) 10 2020 119 359.9

(51) Int. Cl. G06K 7/10; G06K 19/07

(52) U.S. Cl. CPC G06K 7/10297; G06K 7/10366; G06K 19/0723

(57) ABSTRACT

A field device includes a microcontroller-based electronic circuit. The microcontroller-based electronic circuit includes a memory module. The memory module is connected to the microcontroller and configured to store data during operation of the field device. The electronic circuit further includes a wireless interface via which the data can be read out from the memory module.

### CROSS REFERENCE TO RELATED APPLICATIONS

This application claims benefit to German Patent Application No. DE 10 2020 119 359.9, filed on Jul. 22, 2020, which is hereby incorporated by reference herein.

### FIELD

The present disclosure relates to a method for reading out device parameters of a field device and to a corresponding field device.

### BACKGROUND

Configuration data stored in field devices are advantageously taken over for a new device when a field device is replaced. For this purpose, DE102011089346A1 describes a method for operating a field device in process automation technology so as to provide the basic function of the field device even if the energy supply of the field device, for example by means of the field bus, were to fail.

If the event of a total failure of the field device, however, it can be time-consuming to retrospectively find the fault that caused the field device to fail. The faults may have been environmental influences (vibrations, fire, pressure, etc.) or operational faults (interruption of update).

Microcontroller-based electronic circuits, as used in field devices such as a field bus station having communications interfaces and inputs/outputs or a sensor unit or infrastructure components such as switches, are exposed to many damaging environmental conditions and/or can be destroyed by incorrect operation. These electronic circuits are protected against such environmental and usage conditions by suitable measures. These include mechanical and structural solutions, such as housings, seals, potting, paints and encapsulation with plastics, which enclose these circuits and protect them against mechanical influences (shocks, vibrations) and prevent the entry of water or other damaging materials. Technical solutions that can prevent, for example, destructive voltage peaks, overloading, overheating or incorrect use or usage within particular limits are also used. All stresses that can occur beyond that destroy the electronic circuit or its components in the short or long term. Normally, the user of the device is made aware of these by means of instruction manuals and information in standards, so as to ensure that these electronic circuits are not used beyond the stated load limits or destroyed as a result of any other incorrect use. For example, incorrect use could be excessive ambient temperature, operation under water, excessive current or voltage, or vibrational stresses. A further source of faults is when the energy supply is interrupted during critical operational statuses of a device, for example when it is undergoing a software update.

Despite all the protective measures and instructions and operating restrictions, electronic circuits and devices are still destroyed. Once these circuits or devices have been destroyed, they are no longer fit for operation, for the avoidance of doubt.

### SUMMARY

In an embodiment, the present invention provides a field device that includes a microcontroller-based electronic circuit. The microcontroller-based electronic circuit includes a memory module connected to the microcontroller and configured to store data during operation of the field device and a wireless interface via which the data can be read out from the memory module.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a field device having a microcontroller-based circuit.

### DETAILED DESCRIPTION

Therefore, the present disclosure provides a field device in which it is simpler to find the fault in the event of a total failure, and provides a method for reading out device parameters, operation data or operational statuses of a field device that can be carried out in the event of a total failure of the field device.

A field device according to the present disclosure includes a microcontroller-based electronic circuit, comprising a memory module that is connected to the microcontroller and configured to store data during operation of the field device, wherein a wireless interface is provided via which the data can be read out from the memory module.

A field device is preferably a field bus station having communications interfaces and inputs/outputs or a sensor unit or infrastructure components such as switches.

In particular, semiconductor chips containing a processor and also peripheral functions at the same time are referred to as microcontrollers (also called μController, μC, MCU). In many cases, the working and program memory is also located on the same chip either in part or in full. A microcontroller is a single-chip computer system. The term “system on a chip” or “SoC” is also used for some microcontrollers. Preferably, complex peripheral functions are also found on microcontrollers, for example controller area network (CAN) interfaces, local interconnect network (LIN) interfaces, universal serial bus (USB) interfaces, inter-integrated circuit (I2C) interfaces, serial peripheral interfaces (SPI), serial or ethernet interfaces, PWM outputs, LCD controllers and drivers, and A/D converters. Preferably, microcontrollers also have programmable digital and/or analogue or hybrid functional blocks.

The memory module is preferably a separate memory module configured separately from the microcontroller and merely connected to the microcontroller. It is also possible for the memory module to be constructed together with the microcontroller and for the memory module to be located on the same chip as the microcontroller. The memory module can also be integrated in a tag of the wireless interface, in particular in an RFID/NFC tag. The memory module can have a first interface, by which it can be connected to the microcontroller, and a second interface, which is wireless and via which it can be read out and preferably also written to.

The memory module is configured to store data or information during operation of the field device. These data or information can contain valuable application information (device configuration, programs, usage information, etc.) or other operational information, such as the number of overloads detected during operation, measured environmental values such as temperature or moisture, operating hours, or the latest status information, such as “Currently undergoing system software update”, “Voltage peak detected”, “Ambient temperature too high” etc. For this purpose, the memory module is preferably connected to the microcontroller in an electrically conductive manner, particularly preferably likewise via a wireless interface.

The wireless interface via which the data can be read out from the memory module is preferably in the form of a distinct component and is connected to the memory. Via this interface, it is possible to read out the data in the memory module even when the microcontroller is no longer addressable. Particularly preferably, the wireless interface via which the data can be read out from the memory module is formed integral with the memory.

By adding a memory module that is connected to the microcontroller and preferably also addressable as a passive NFC tag to a microcontroller-based electronic circuit of this kind in a field device, the data that have been stored on the memory module during operation can be read out independently of the status of the rest of the components and, by means of an evaluation, it can be determined what led to the (total) failure of the field device. Information that was stored on this memory module can thus be read out “post mortem”. Thus it is possible to still obtain information from a circuit (or device) that is otherwise no longer fit for operation, for example by bringing an RFID reader close to the outside of it.

Often, memory modules can also be released from the destroyed circuits and inserted or addressed in functioning electronic circuits or systems. As a result, the valuable information is available again. However, this is more complex than reading out data via the wireless interface, in particular when the modules are, for example, potted or painted or otherwise not easily accessible in technical terms and thus cannot be removed in a destruction-free manner—potentially only by heat-treatment or release with chemicals. Electronic circuits and devices can thus be analyzed “post mortem” despite no longer being able to be started up. Related findings can serve as evidence of incorrect handling and can avoid warranty or damages claims, or provide valuable information on the status of the device in order to make it simpler to remedy faults for a device type.

In an advantageous field device, the memory module is configured to be addressable as a passive RFID tag. A memory module that is connected to the microcontroller and also addressable as a passive RFID tag is thus added to a microcontroller-based electronic circuit of this kind. It is also possible to use an HF RFID tag or an NFC tag. Preferably, a combination of several tags is used to increase redundancy. In this case, the tags can be several identical tags or several tags of different designs, i.e. RFID tags, HF RFID tags or NFC tags in combination, or tags of different storage capacities in combination. This also makes it possible to store different content on the different memories of the individual tags and thus to retrieve it again by means of different tags and their wireless interfaces.

By means of this RFID tag, information can be read out via the wireless interface even before the device is damaged, and preferably it is also possible to write information to the memory module of the tag via the wireless interface. As a result, maintenance or inspection data, for example, can be stored on the memory module or older data can also be deleted.

Tags having an interface to the microcontroller in addition to the wireless interface are preferably used. The RFID tag having the memory module is thus the data medium for the logged data.

Further preferably, a field device is provided in which the memory module has a transponder, preferably in accordance with the NFC and/or RFID standard.

Near field communication (NFC) is an international transmission standard based on RFID technology for contactlessly exchanging data by electromagnetic induction by means of loose coupled coils over short distances of a few centimetres and at a maximum data transmission rate of 424 kBit/s.

Radio-frequency identification (RFID) denotes a technology for transceiver systems to automatically and contactlessly identify and locate objects and living things using radio waves.

Generally, an RFID system consists of a transponder (also referred to colloquially as a radio tag), which is located on or in the object, thus in this case preferably the memory module, and contains a characteristic code, and of a reader for reading out this identifier.

It is possible to produce RFID transponders from polymers by means of a special printing process for stable circuits.

The coupling is preferably established either by short-range magnetic alternating fields generated by the reader, or by high-frequency radio waves. As a result, preferably not only are data transmitted, but the transponder is supplied with energy too.

The reader preferably contains software (a microprogram) that controls the actual reading process, and particularly preferably also RFID middleware having interfaces to further electronic data processing systems and databases.

Further preferably, a field device is provided in which the memory module and/or the microcontroller is/are installed so as to be inaccessible in technical terms. The modules can thus be protected against environmental influences and damage.

Further preferably, a field device is provided in which the data include station parameters of the device or other operating parameters.

In this context, station parameters preferably comprise necessary configuration data, e.g. device parameters, but also production data.

Operating parameters preferably comprise everything recorded by the microcontroller and loaded into the memory in addition to the station parameters regarding the operating time (e.g. (working) voltage values, reasons for resets, bootloader mode or other significant memory content). Data on temperature, vibrations, radiation, operating time fault codes, statuses and communications parameters can also be recorded. The status can comprise the ongoing exchange of process data, the configuration mode, the start-up phase and data rates in the network. For the working voltage, the charging status of the accumulator or battery can be recorded in particular.

A method according to the present disclosure for reading out device parameters of a field device, wherein data on the operating time of the field device has been stored in the memory module and the field device then has a malfunction in which the field device cannot communicate by means of wired channels, the microcontroller or the processing unit of the field device is no longer addressable and the field device is not connected to a power supply, includes the step of: reading out the data from the memory module via the wireless interface.

Further preferably, a method is provided that further comprises the step of: reading out the data from the memory module via the wireless interface by means of RFID or NFC.

Further preferably, a method is provided that further comprises the step of: displaying the read-out data on a mobile terminal. A portable computer, a smartphone or a reader can be used as the mobile terminal.

Further preferably, a method is provided that further comprises the step of: interpreting the read-out data on the basis of a predefined evaluation mapping.

Preferably, this evaluation mapping is structured in a database. The database can preferably be called up in a location-independent manner, in particular via the internet or a website. Preferably, the database is configured to be centrally supplemented with product-related fault codes or status codes. The database is preferably configured such that corresponding fault codes or status codes can be output in text form (human-readable and interpretable) by means of the identifying features of the product (product name, ID, batch number).

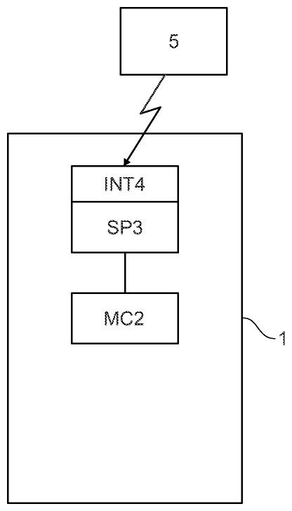

FIG. 1 shows a schematic view of a field device (1) having a microcontroller-based circuit, comprising a microcontroller (MC2) and a memory module (SP3) connected thereto. A wireless interface (INT4) is also provided.

During operation, data are written to the memory module (SP3) by the microcontroller (MC2).

The data are transmitted to a mobile terminal (5) via the wireless interface (INT4).

Preferably, the memory module (SP3) and the wireless interface are an RFID tag. This RFID tag is connected to the microcontroller (MC2) and is configured to store the data made available by the microcontroller (MC2). The data can be data such as statuses, for example that an update is currently being loaded and installed, or environmental parameters such as temperature, vibrations or moisture.

If the field device (1) now fails and the microcontroller (MC2) is no longer addressable, a mobile terminal (5), for example a laptop or a smartphone, can be used to read out the content of the memory module (SP3), i.e. of the RFID tag, via the interface (INTO). The data obtained therefrom can then be displayed on the mobile terminal (5) and visualized by interpreting the read-out data on the basis of a predefined evaluation mapping. The data can thus be evaluated, and it can be displayed to the operator of the mobile terminal (5) on a display that an update has been installed, during the process of which vibrations increased and shortly after that the working voltage dropped out.

By way of the field device and the method for reading out parameters from that field device, it is possible to establish, even after damage has occurred, which circumstances caused the device to fail since this data can be read out “post mortem” via the wireless interface without any need for a complex analysis and mechanical release of parts, which, for example, may have been potted in. Replacement devices can thus also be parameterized and the role of the damaged device taken over in a timely manner.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Field device

2 Microcontroller MC2

3 Memory module SP3

4 Wireless interface INT4

5 Data mobile terminal

1. A field device comprising:
a microcontroller-based electronic circuit, comprising:
a memory module connected to the microcontroller and configured to store data during operation of the field device; and,
a wireless interface via which the data can be read out from the memory module.

2. The field device according to claim 1, wherein the memory module is configured to be addressable as a passive RFID tag.

3. The field device according to claim 1, wherein the memory module has a transponder.

4. The field device according to claim 1, wherein the memory module and/or the microcontroller is/are installed so as to be inaccessible in technical terms.

5. The field device according to claim 1, wherein the data comprise station parameters of the field device or other operating parameters.

6. A method for reading out device parameters of a field device according to, the method comprising:
storing data on the operating time of the field device in the memory module; and
reading out the data, after the field device has a malfunction in which the field device cannot communicate via wired channels, a microcontroller of the field device is no longer addressable, and the field device is not connected to a power supply, from a memory module via a wireless interface.

7. The method according to claim 6, wherein the reading out the data from the memory module via the wireless interface is performed via RFID or NFC.

8. The method according to claim 6, further comprising displaying the read-out data on a mobile terminal.

9. The method according to claim 6, further comprising interpreting the read-out data based on a predefined evaluation mapping.
